(19) United States
(12) Patent Application Publication
(10) Pub. No.: US 2007/0108774 A1
(43) Pub. Date: May 17, 2007

(54) Archimedes power generator

(76) Inventor: Bruce Charles Estes, Windham, ME (US)

Correspondence Address: Bruce Charles Estes, 23 Overlook Rd, Windham, ME, 04062, US

(21) Appl. No.: 11/272,496

(22) Filed: Nov. 14, 2005

(51) Int. Cl. F03B 13/12

(52) U.S. Cl. 290/53

(57) ABSTRACT

The Archimedes Power Generator is a process designed to produce electric power from rising and falling water levels of the ocean due to tidal motion. The generator is composed of a barge enclosed within a containment area that has holes built into the containment walls allowing the barge to rise and fall in unison with the tides. On the top of the barge is a turbine, or series of turbines. Each turbine is connected to a toothed shaft that is installed through the barge (using seals to keep out water) and solidly attached to the bottom of the containment area. The toothed shaft is linked to a toothed gear on the turbine so that as the barge rises and falls, the armature of the turbine spins, creating the potential for the production of electricity.

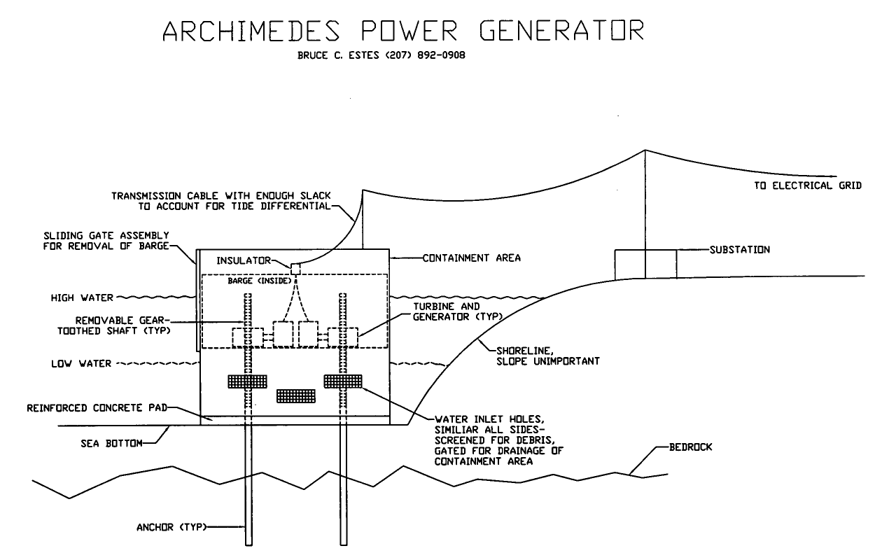

### BACKGROUND OF THE INVENTION

Generation of electric power generally basically requires two fundamental items; a generator that actually produces the electric voltage required to produce current, and a prime-mover that drives the generator. This paper focuses on the prime mover, but also includes ideas on coupling to the generator, and on connections from the generator to the transmission system.

Archimedes Principle states that the upward buoyant force on a floating object is equal to the weight of the water displaced. Archimedes Power Plant is based upon this principle. This force can be converted to usable watts when motion is applied to the principle. Mathematics of sizes, conversions and general engineering are already developed and are details of construction.

### DETAILED DESCRIPTION OF THE INVENTION

Basically here is how the system would be built, and operate;

I. A dry-dock (containment area) arrangement is built into the ocean. Capable of being drained as needed for maintenance.
A. The dry-dock has a series of holes in the walls designed so that they would always be under water, allowing the water level (and hence the barge) within the containment area to rise and fall in unison with the tide.
B. Inlet/outlet holes are a detail to be designed later, however they would have to be large enough to allow the water in the containment to rise and fall at the same rate as the tide.
C. The containment is designed for the area being installed and would vary from site to site. It could be built as deep as needed for convenience, provided the holes are placed to maximize water flow, and minimize inflow of particulate and debris.

II. Within this dry-dock/containment area, is a “barge”. The barge is built just smaller than the inside diameter of the containment walls. The barge can be prevented from any sideways motion by removable rollers attached to each side of the barge allowing the barge to rise and fall vertically, yet stay in the exact horizontal plane.
A. Inside the barge is a turbine. The turbine is composed of a large gear. A rigid-toothed shaft is attached to the bottom of the containment area and runs up through a sealed hole in the bottom of the barge and engages the large gear.
B. As the barge rises and lowers with the tide, the buoyant force on incoming tide, and the gravitational force on outgoing tide is converted to rotational force on the turbine.
C. The rotational force on the turbine is then transferred to the generator via a shaft, converting the force to electricity. Phase reversal electronics would be employed to deal with the opposite direction of rotation of the turbine from the rising, or lowering of the tide. In this way, usable energy is created during rising and falling tides.
D. The holes in the containment area are located far enough below the low-water line to eliminate “surging” of the barge due to wave action at the surface.

III. Speed/frequency can be controlled via electronics. There would be zero power output at both slack tides.

IV. Turbine and generator can be housed within the barge, protecting them from the elements and corrosive environment. Electrical connections to the grid could be made via insulators and a slack-cable arrangement located on top of the barge. It should also be noted here that several turbine-generator units (each with its own shaft) could be housed within the same barge.

V. Maintenance
A. The containment area is built with a sliding water-tight gate at the front, allowing the barge to be extracted at high tide. The barge is then anchored outside the gate, the gate closed, and the containment evacuated of water to allow for cleaning and other required maintenance. Design of this sliding gate is a detail.
B. A mobile suctioning device could also be used at the bottom of the containment to remove silt and particles that enter the containment area during operation.

VI. Anti-fouling and cathodic protection is installed at required locations to prevent growth of sea-life and corrosion on the equipment. These items have already been developed, and are not considered original for this application.

VII. The accompanying drawing (1) shows an elevation view of the components and an example of the arrangement of the components on a working prototype.

The items above give the general description of the idea and process.

Advantages:

1. Completely renewable with little impact on the environment.

2. Simple design and implementation.

1. I claim the containment area is my original idea.
I claim the holes in the bottom of the containment area for the inflow and outflow of water is my original idea.
I claim the water/pressure tight sliding gate for the holes for inlet and outflow of water as my original idea.
I claim the water/pressure tight sliding gate for the removal of the barge as my original idea.

2. I claim the barge is my original idea.
I claim the idea of the turbines and generator being placed on the barge as my original idea.
I claim the use of seals around the toothed shaft as my original idea.

3. I claim the turbine concept as my original idea.
I claim the rotation of the turbine from the rise and fall of the tide via the toothed shaft and gear as my original idea.
I claim the anchoring of the toothed shaft to the concrete floor of the containment area as my original idea.
